(19) United States
(12) Patent Application Publication
(10) Pub. No.: US 2005/0195701 A1
(43) Pub. Date: Sep. 8, 2005

(54) Compact disc processing system and a transportation method for compact discs

(75) Inventors: Ming-Hsun Liu, Taipei (TW); Chung-Hsuan Tsai, Taipei (TW)

Correspondence Address: BACON & THOMAS, PLLC, 625 SLATERS LANE, FOURTH FLOOR, ALEXANDRIA, VA, 22314, US

(73) Assignee: MING-HSUN LIU, His-Chih (TW)

(21) Appl. No.: 11/068,961

(22) Filed: Mar. 2, 2005

(30) Foreign Application Priority Data
Mar. 8, 2004 (TW) 093106020

(51) Int. Cl. G11B 17/22

(52) U.S. Cl. 369/30.34; 369/30.83

(57) ABSTRACT

A compact disc processing system includes: a compact disc processing device having a top section forming a sealed circumference, the compact disc processing device comprising a compact disc horizontal carrying device capable of extending from the compact disc processing device to provide a waiting position for loading or unloading a compact disc; a first compact disc storage unit placed above a top section of the compact disc processing device and defining a first compact disc storage position for storing the compact disc; a second compact disc storage unit placed outside of the compact disc processing device and defining a second compact disc storage position for storing the compact disc; and a compact disc transportation device for moving one compact disc between the first compact disc storage position and the waiting position, and between the second compact disc storage position and the waiting position.

### BACKGROUND OF THE INVENTION

1. Field of the Invention The present invention relates to a compact disc processing system and a transportation method for compact discs, and more particularly, to a transportation method for processed compact discs.

2. Description of the Related Art

All optical compact discs can be reproduced for a small amount or a reasonable amount by a reproduction system, such as the system claimed in U.S. Pat. No. 6,141,298. However, this system requires an enormous amount of space, which is very inconvenient in terms of transportation and operation. Furthermore, due to its complex structure, it also imposes high manufacturing costs.

U.S. Pat. No. 6,490,232 discloses a compact disc feeder, which utilizes a transfer device 6 to drive an arm 12, which moves and rotates to take a disc from a holder 5, and then places it into a tray 49 of a printer 48; then the compact disc which has been printed, is drawn from the printer 48 and stacked in a lower holder 5. However, this device still requires large amounts of space.

U.S. Pat. No. 5,481,514 discloses a recording/reproducing apparatus for a disk-like recording medium, which can move between two abreast tray stockers 104, 105 and move one of the tray stocker 104 to a reproduction unit 206, and than back to the tray stocker 105. The two abreast tray stockers 104, 105 still require large amounts of space.

Therefore, it is desirable to provide a compact disc processing system and a transportation method for compact discs to mitigate and/or obviate the aforementioned problems.

### SUMMARY OF THE INVENTION

A main objective of the present invention is to provide a compact disc processing system, such as a compact disc reproduction system, duplication system, printing system, coating system or laminating system, and a transportation method for compact discs, which can utilize the head space in the compact disc processing device for storing compact discs to solve problems associated with space.

Another objective of the present invention is to provide a compact disc processing system and a transportation method for compact discs, which provides a simple structure to reduce manufacturing costs.

The compact disc processing system of the present invention comprises: a compact disc processing device having a top section forming a sealed circumference, the compact disc processing device comprising a compact disc horizontal carrying device capable of extending from the compact disc processing device to provide a waiting position for loading or unloading a compact disc; a first compact disc storage unit placed above the top section of the compact disc processing device and defining a first compact disc storage position for storing the compact disc; and a second compact disc storage unit placed outside of the compact disc processing device and defining a second compact disc storage position for storing the compact disc.

The present invention further provides a transportation method for compact discs to move one compact disc between the first compact disc storage position and the waiting position, and between the second compact disc storage position and the waiting position.

Any one of the compact disc storage units can be plural and used for storing blank compact discs and/or processed compact discs.

The compact disc processing device comprises: (a) a lifting unit having a vertical central line; (b) a rotating unit having a first end connected to the lifting unit and rotating around the central line, and a second end; (c) a capturing structure mounted at the second end of the rotating unit for grabbing the compact disc, the capturing structure having a capturing central point corresponding to a central point of the compact disc; and (d) a driving device having a first power unit, a screw capable of being driven by the first power unit, the center of the screw being placed along the central line and screwed to the first end of the rotating unit, a guide track mounted along outside of the central line of the lifting unit and slidably connected to the first end of the rotating unit to drive the rotating unit along the central line to move and rotate.

The guide track of the driving device further comprises: (a) a first lifting section having a first end and a second end, wherein the first end and the second end of the first lifting section causes the capturing central point of the capturing structure at the second end of the rotating unit to align with the second compact disc storage position; (b) a first rotating section having a third end and a fourth end, wherein the third end causes the capturing central point of the capturing structure at the second end of the rotating unit to align with the second compact disc storage position, and the fourth end causes the capturing central point of the capturing structure at the second end of the rotating unit to align with the waiting position; and (c) a second lifting section having a fifth end and a sixth end, wherein the fifth end causes the capturing central point of the capturing structure at the second end of the rotating unit to align with the waiting position, and the sixth end causes the capturing central point of the capturing structure at the second end of the rotating unit to align with the first compact disc storage position.

The first end and the second end of the first lifting section further comprise a positioning section for the first end of the rotating unit to touch against for positioned lifting.

The third end and the fourth end of the first lifting section further comprise a positioning section for the first end of the rotating unit to touch against for positioned lifting.

The fifth end and the sixth end of the first lifting section further comprise a positioning section for the first end of the rotating unit to touch against for positioned lifting.

The compact disc processing system further comprises a third compact disc storage unit placed outside of the compact disc processing device and defining a third storage position for storing the compact disc.

The guide track of the driving device further comprises: (d) a second rotating section having a seventh end and an eighth end, wherein the seventh end causes the capturing central point of the capturing structure at the second end of the rotating unit to align with the waiting position, and the eighth end causes the capturing central point of the capturing structure at the second end of the rotating unit to align outside of the compact disc processing device so that the compact disc drops onto the third compact disc storage position.

The seventh end and the eighth end of the second lifting section further comprise a positioning section for the first end of the rotating unit to touch against for positioned lifting.

The compact disc comprises a circumference, a first compact disc surface connected to one end of the circumference, a second compact disc surface connected to another end of the circumference, a central hole having two ends connected to the first compact disc surface and the second compact disc surface, and a circular protrusion on the first compact disc surface forming a protrusive surface, a distance between the first compact disc surface and the second compact disc surface defining a minimum compact disc thickness, and a distance between the first compact disc surface and the protrusive surface defining a maximum compact disc thickness. The capturing structure of the compact disc processing system comprises: (a) a second power unit; (b) a transmission mechanism connected to the second power unit; (c) a driving mechanism connected to the transmission mechanism; and (d) at least two capturing members connected to the driving mechanism to close or open, each capturing member comprising a hook having sharp V-type edge, and a stopping block capable of touching the compact disc, a distance between the hook and the stopping block defining a capturing thickness, the capturing thickness being larger than the minimum compact disc thickness and smaller than the maximum compact disc thickness so that the hook can accurately reach into a gap between two stacked compact discs to grab the top compact disc.

Any one of the compact disc storage unit comprises: (a) a compact disc seat; and (b) a plurality of compact disc positioning members, each compact disc positioning member having a pivot center, the plurality of compact disc positioning members being separately pivoted at different positions on the compact disc seat, each compact disc positioning member having a plurality of positioning edges, each positioning edge having a different distance to the pivot center to selectively set the positioning edges of the compact disc positioning members by pivoting the plurality of compact disc positioning members relatively to the compact disc seat so a concentric circle with a predetermined diameter can be defined for different compact disc sizes.

The present invention further provides a compact disc processing system, which comprises: a compact disc processing device; a plurality of compact disc storage units placed above a top section of the compact disc processing device for storing a compact disc.

Any one of the compact disc storage units is used for storing blank compact discs and/or processed compact discs.

Any one of the compact disc storage units can be plural and used for storing blank compact discs and/or processed compact discs.

The present invention further provides a transportation method for compact discs, which comprises: a compact disc horizontal carrying device in a compact disc processing device extending internally from the compact disc processing device to provide a waiting position for loading or unloading a compact disc; placing a first compact disc storage unit above the top section of the compact disc processing device to define a second compact disc storage position for storing the compact disc; placing a second compact disc storage unit above the top section of the compact disc processing device to define a first compact disc storage position for storing the compact disc; moving one compact disc between the first compact disc storage position and the waiting position and between the second compact disc storage position and the waiting position.

Any one of the compact disc storage units is used for storing blank compact discs and/or processed compact discs.

Any one of the compact disc storage units can be plural and used for storing blank compact discs and/or processed compact discs.

Other objects, advantages, and novel features of the invention will become more apparent from the following detailed description when taken in conjunction with the accompanying drawings.

### BRIEF DESCRIPTION OF THE DRAWINGS

FIG. 1 is an exploded view of the present invention.

FIG. 2 is another exploded view of the present invention (after removing a top cover).

FIG. 3 is a top view of the present invention (after removing a top cover).

FIG. 4 is a detailed view of a circled area in FIG. 3.

FIG. 5 is a right side view of the present invention (after removing a top cover).

FIG. 6 is a front view drawing of the present invention (after removing a top cover).

FIG. 7 is an exploded view of a compact disc transportation device of the present invention.

FIG. 8 is an exploded view of a lifting unit of the present invention.

FIG. 9 is an exploded view of a guide track of the present invention.

FIG. 10 is another exploded view of the guide track of the present invention.

FIG. 11 is a top view of a guide track of the present invention.

FIG. 12 is a front view of a guide track of the present invention.

FIG. 13 is a right side view of a guide track of the present invention.

FIG. 14 is a back view of a guide track of the present invention.

FIG. 15 is a detailed view of an upper section of FIG. 12.

FIG. 16 is an exploded view of a compact disc capturing member of the present invention.

FIG. 17 is another exploded view of a compact disc capturing member of the present invention.

FIG. 18 is a top view of a compact disc capturing member of the present invention FIG. 19 is a cross-sectional drawing along a cross-sectional line 19-19 depicted in FIG. 18.

FIG. 20 is a detailed view of an encircled area in FIG. 19.

FIG. 21 is a detailed view of an encircled area in FIG. 20.

FIG. 22 is an exploded view of a second compact disc storage unit of the present invention.

FIG. 23 is a top view of the compact disc storage unit of the present invention.

FIG. 24 is a cross-sectional drawing of a typical compact disc.

FIG. 25 is a detailed view of an encircled area in FIG. 24.

### DETAILED DESCRIPTION OF THE PREFERRED EMBODIMENT

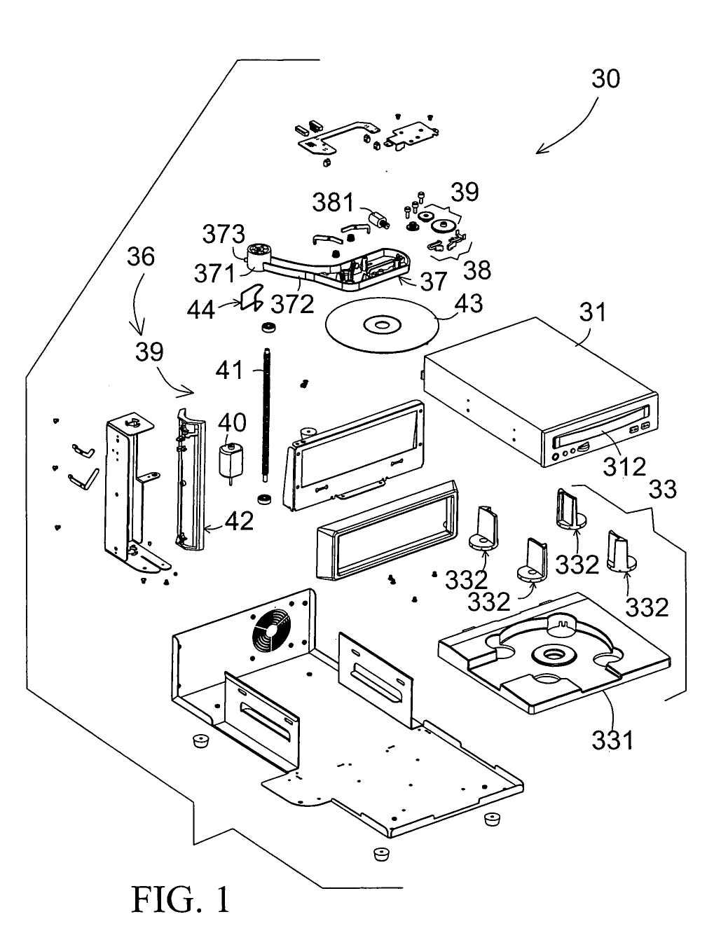

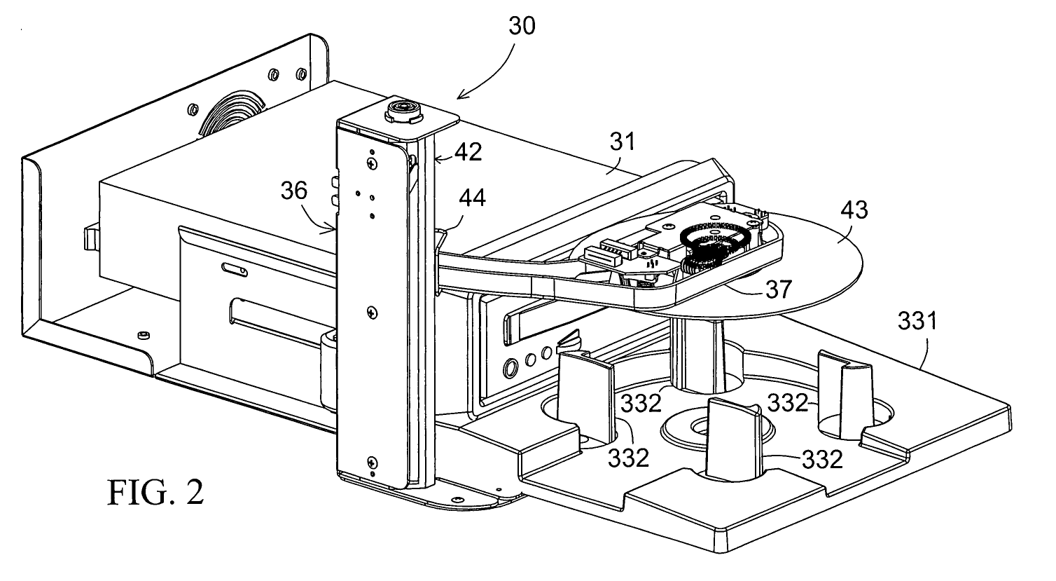

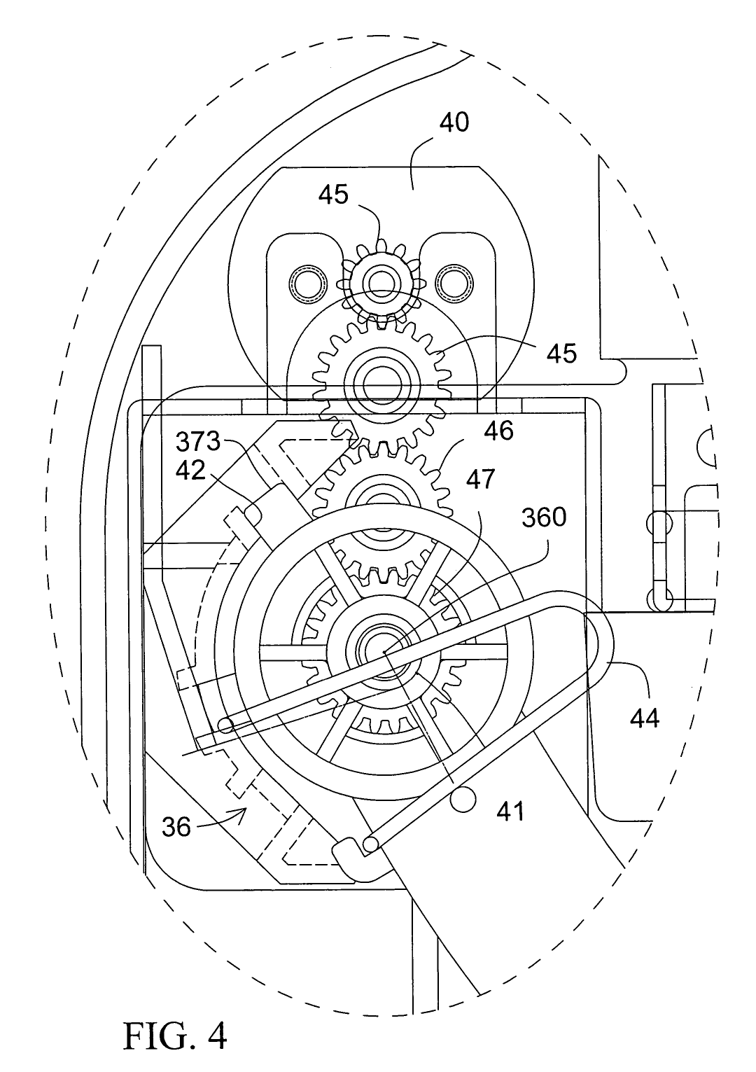

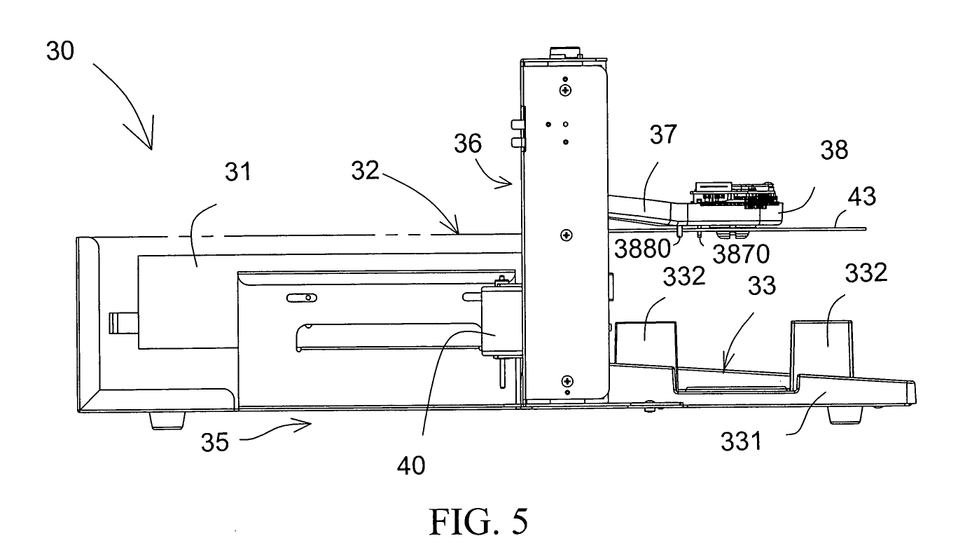

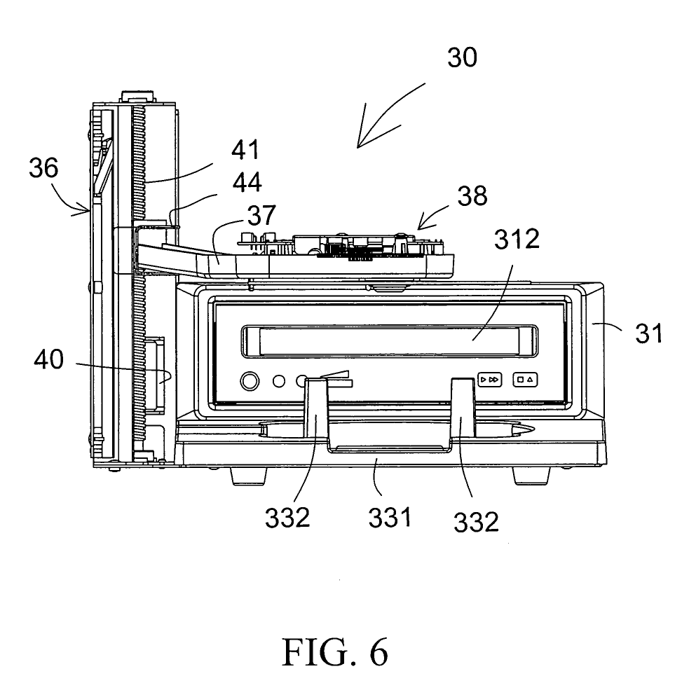

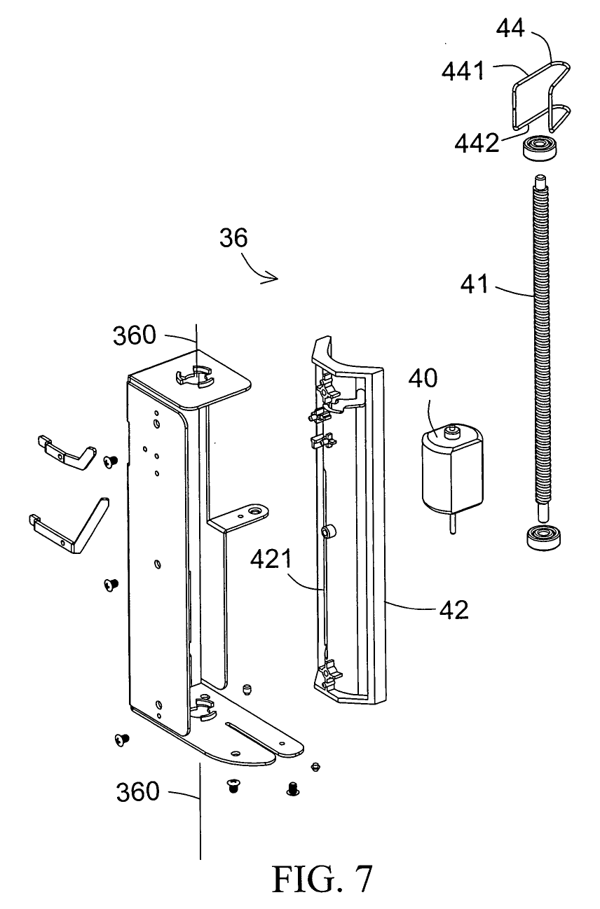

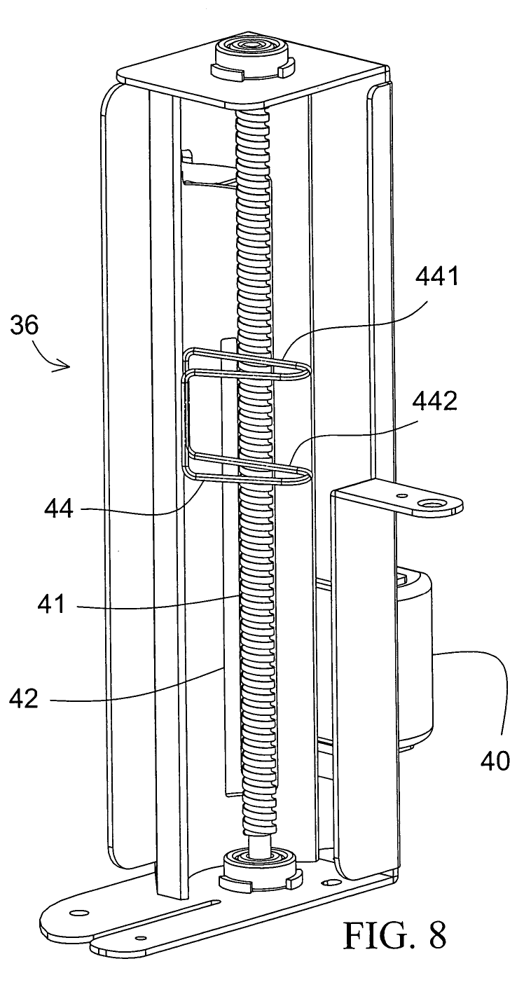

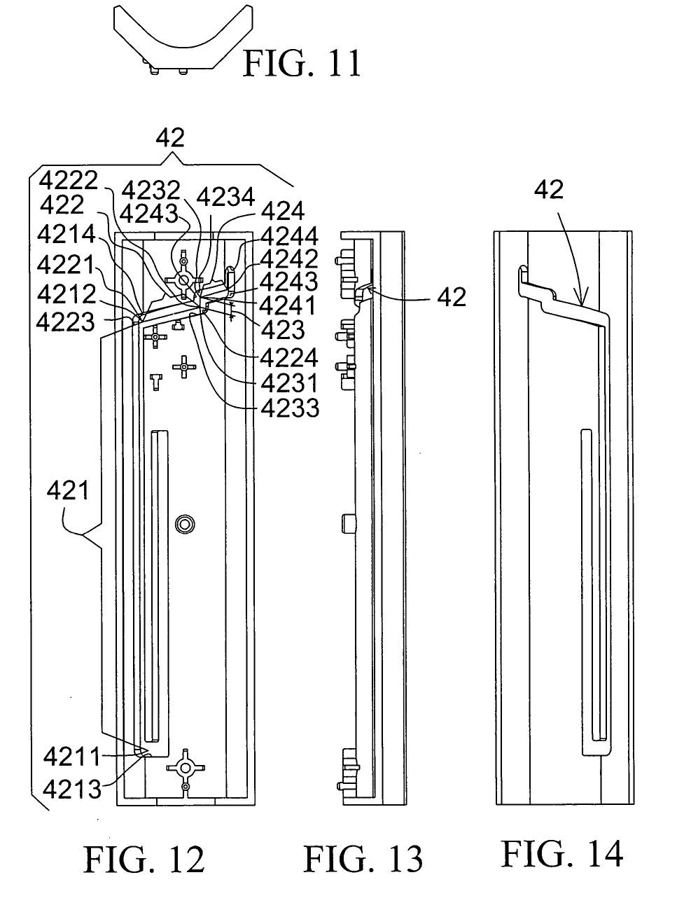

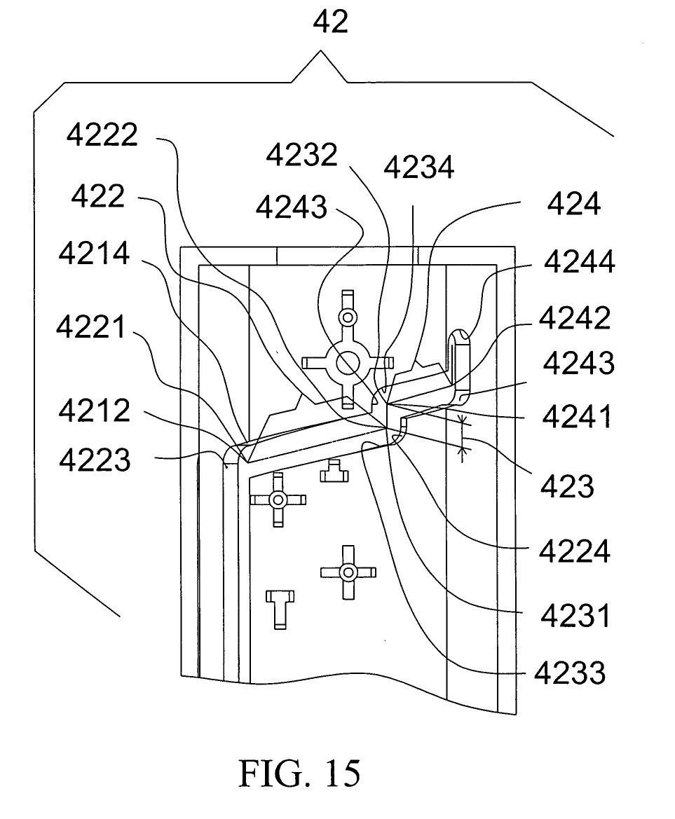

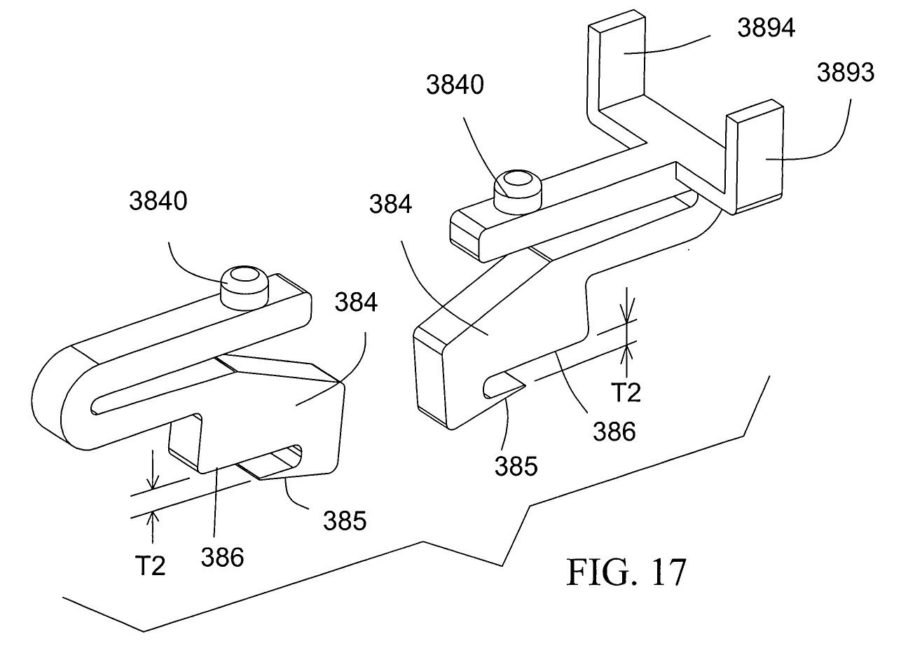

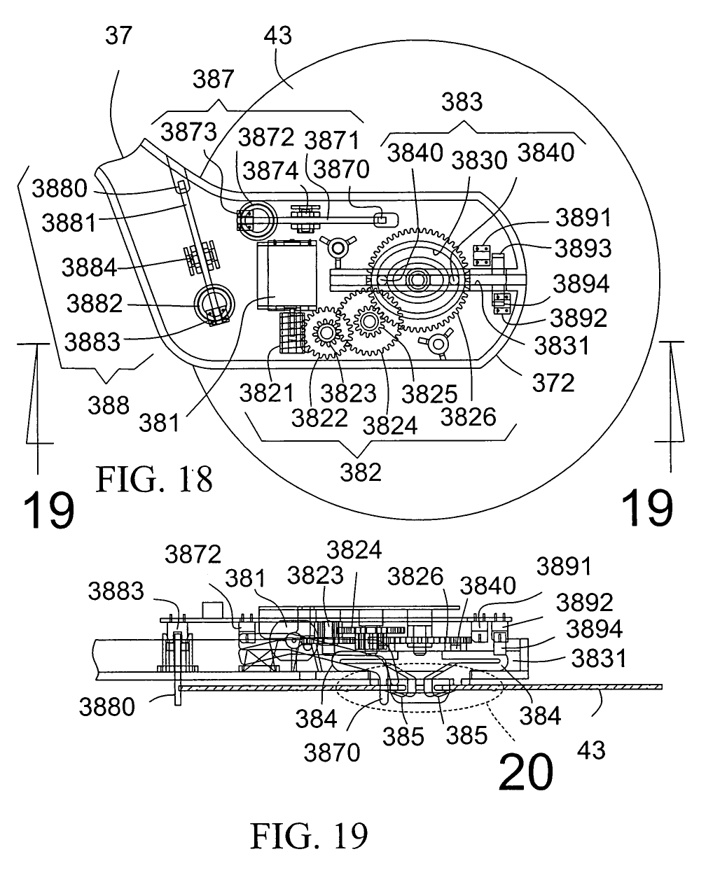

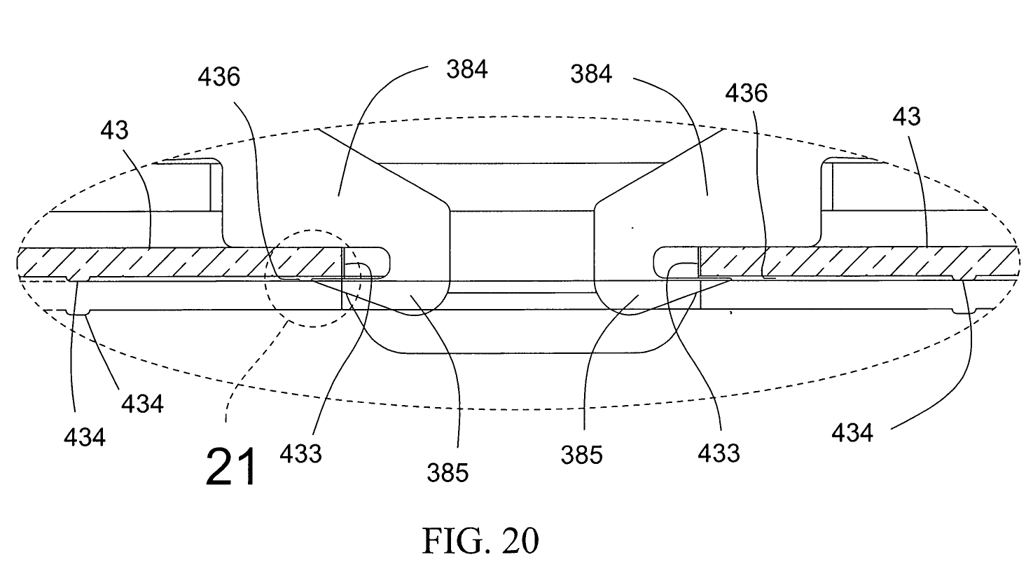

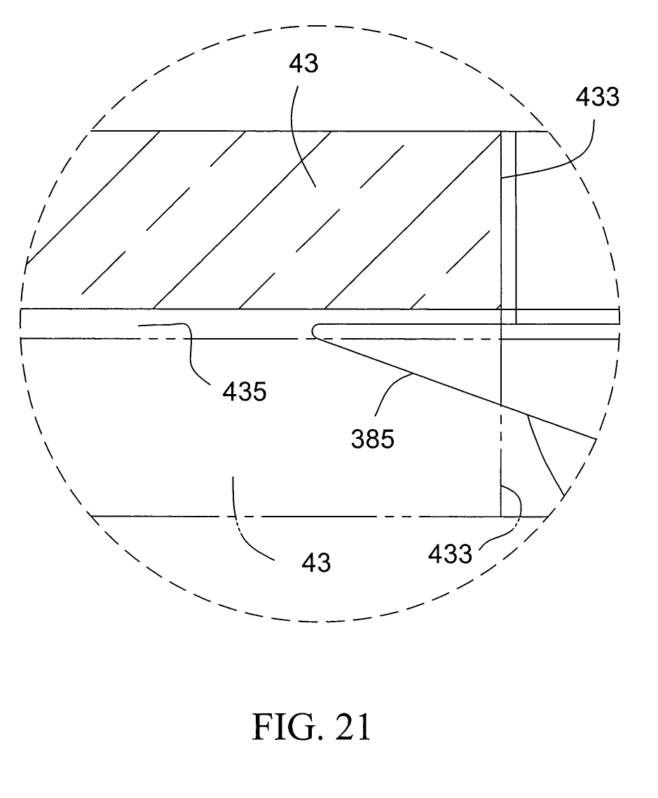

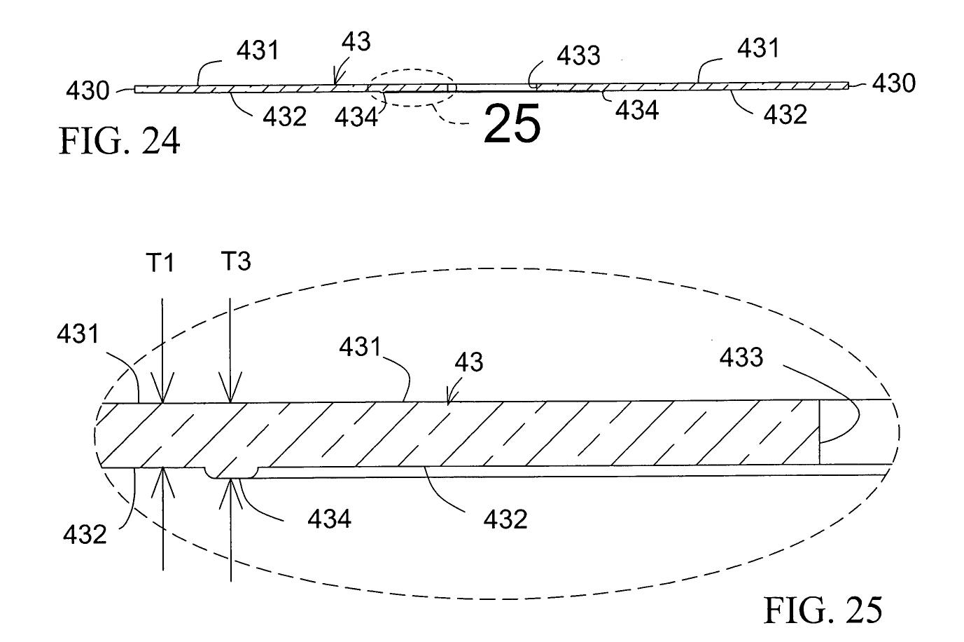

Please refer to FIG. 1 to FIG. 25. A compact disc processing system (30), such as reproduction system, duplication system, printing system, coating system or laminating system, of the present invention comprises: a compact disc processing device (31), a first compact disc storage unit (32), a second compact disc storage unit (33) and a compact disc transportation device (34).

Please refer to FIG. 1 to FIG. 6. The compact disc processing device (31) has a top section (311), and the top section (311) forms a sealed circumference. The compact disc processing device (31) comprises a compact disc horizontal carrying device (312), which extends from an internal position within the compact disc processing device (31) to provide a waiting position for loading or unloading a compact disc.

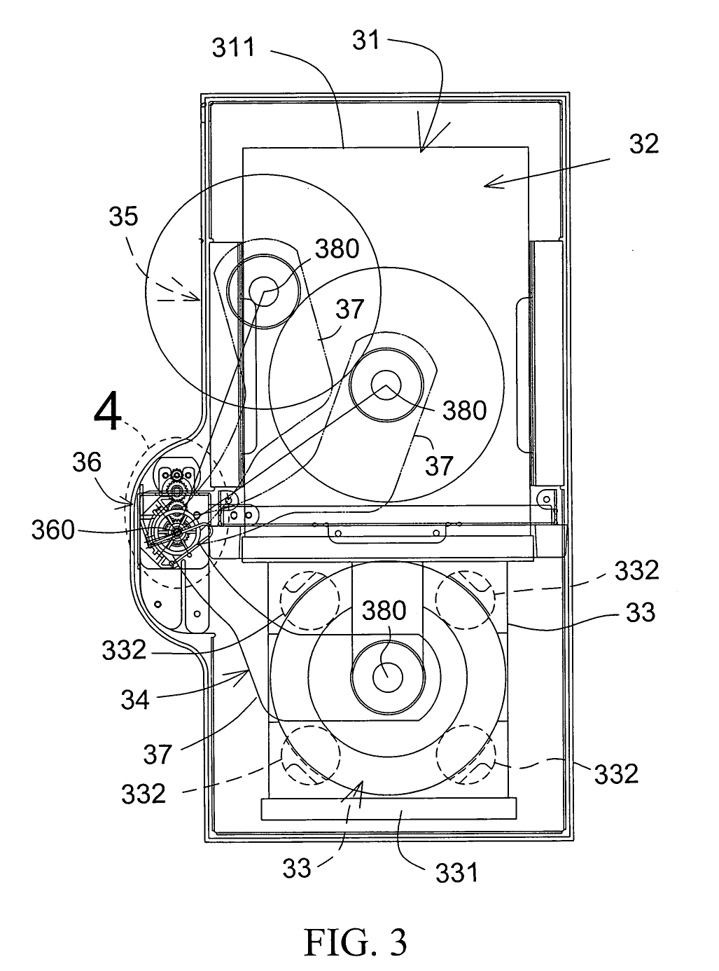

Please refer to FIG. 3. The first compact disc storage unit (32) is placed above the top section (311) of the compact disc processing device (31) and defines as a first compact disc storage position for storing compact discs. The second compact disc storage unit (33) is placed outside of the compact disc processing device (31) and defines as a second compact disc storage position for storing compact discs.

Please refer to FIG. 3. The compact disc processing system (30) of the present invention further comprises a third compact disc storage unit (35), which is placed outside of the compact disc processing device (31) and defines a third compact disc storage position for storing compact discs.

Please refer to FIG. 3. The compact disc transportation device (34) moves one compact disc between the first compact disc storage position and the waiting position or between the second compact disc storage position and the waiting position.

There can be multiple numbers of first compact disc storage units (32) and second compact disc storage units (33), which are used for storing blank compact discs and/or processed compact discs.

Please refer to FIG. 1 to FIG. 6. The compact disc transportation device (34) comprises: a lifting unit (36), a rotating unit (37), a capturing structure (38), and a driving device (39). The lifting unit (36) has a vertical central line (360). The rotating unit (37) has a first end (371) connected to the lifting unit (36) and rotating around the central line (360), and a second end (372).

Please refer to FIG. 1 to FIG. 25. The capturing structure (38) is mounted at the second end (372) of the rotating unit (37) for gripping a compact disc, and the capturing structure (38) has a capturing central point (380) corresponding to a central point (436) of the compact disc.

Please refer to FIG. 1 to FIG. 25. The driving device (39) has a first power unit (40) (which is a motor in this embodiment), a screw (41), and a guide track (42). The screw (41) is able to be driven by the first power unit (40). The center of the screw (41) is placed along the central line (360) and is screwed to the first end (371) of the rotating unit (37) via two arms (441), (442) of a spring (44).

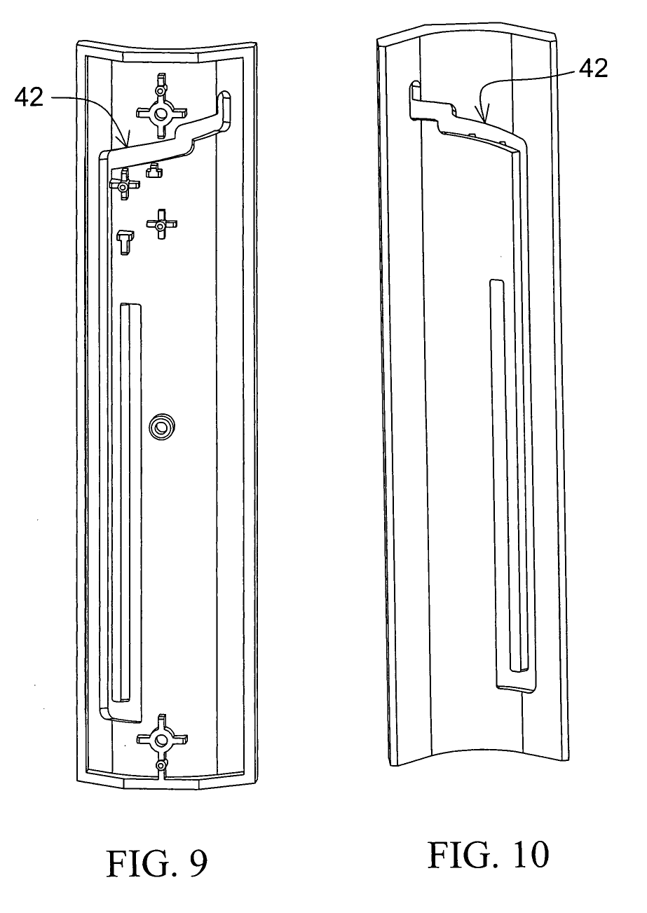

Please refer to FIG. 9 to FIG. 15. The guide track (42) is a guide slot and is mounted along outside of the central line (360) of the lifting unit (36), and is slidably connected to a protrusive section (373) of the first end (371) of the rotating unit (37) to drive the rotating unit (37) along the central line (360) to move and rotate the guide track (42).

Please refer to FIG. 9 to FIG. 15. The guide track (42) of the driving device (39) further comprises: a first lifting section (421), a first rotating section (422), and a second rotating section (423). The first lifting section (421) has a first end (4211) and a second end (4212), wherein the first end (4211) and the second end (4212) of the first lifting section (421) cause the capturing central point (380) of the capturing structure (38) at the second end (372) of the rotating unit (37) to align with the second compact disc storage position. The first end (4211) and the second end (4212) of the first lifting section (421) both further comprise a positioning section (4213), (4214) against which the protrusive section (373) of the first end (371) of the rotating unit (37) may touch for positioned lifting.

Please refer to FIG. 9 to FIG. 15. The first rotating section (422) has a third end (4221) and a fourth end (4222). The third end (4221) makes the capturing central point (380) of the capturing structure (38) at the second end (372) of the rotating unit (37) align with the second compact disc storage position, and the fourth end (4222) makes the capturing central point (380) of the capturing structure (38) at the second end (372) of the rotating unit (37) align with the waiting position. The third end (4221) and the fourth end (4222) of the first lifting section (421) both further comprise a positioning section (4223), (4224) against which the protrusive section (373) of the first end (371) of the rotating unit (37) may touch for positioned lifting.

Please refer to FIG. 9 to FIG. 15. The second lifting section (423) has a fifth end (4231) and a sixth end (4232), wherein the fifth end (4231) makes the capturing central point (380) of the capturing structure (38) at the second end (372) of the rotating unit (37) align with the waiting position, and the sixth end (4232) makes the capturing central point (380) of the capturing structure (38) at the second end (372) of the rotating unit (37) align with the first compact disc storage position. The fifth end (4231) and the fourth end (4232) of the second lifting section (423) both further comprise a positioning section (4233), (4234) for the protrusive section (373) of the first end (371) of the rotating unit (37) to touch against for positioned lifting.

Please refer to FIG. 9 to FIG. 15. The guide track (42) of the driving device (39) further comprises a second rotating section (424), which has a seventh end (4241) and an eighth end (4242). The seventh end (4241) makes the capturing central point (380) of the capturing structure (38) at the second end (372) of the rotating unit (37) align with the waiting position, and the eighth end (4242) makes the capturing central point (380) of the capturing structure (38) at the second end (372) of the rotating unit (37) align outside of the compact disc processing device so that the compact disc drops onto the third compact disc storage position. The seventh end (4241) and the eighth end (4242) of the second lifting section (423) both further comprise a positioning section (4243), (4244) for the protrusive section (373) of the first end (371) of the rotating unit (37) to touch against for positioned lifting.

Please refer to FIG. 19 to FIG. 25. The typical compact disc (43) comprises: a circumference (430), a first compact disc surface (431), a second compact disc surface (432), (433), a central hole and a circular protrusion (434). The first compact disc surface (431) is connected to one end of the circumference (430). The second compact disc surface (432) is connected to another end of the circumference (430). The central hole (433) has two ends connected to the first compact disc surface (431) and the second compact disc surface (432). The circular protrusion (434) on the first compact disc surface (431) forms a protrusive surface. A distance between the first compact disc surface (431) and the second compact disc surface (432) is defined as a minimum compact disc thickness (Ti), and a distance between the first compact disc surface (431) and the protrusive surface is defined as a maximum compact disc thickness (T3).

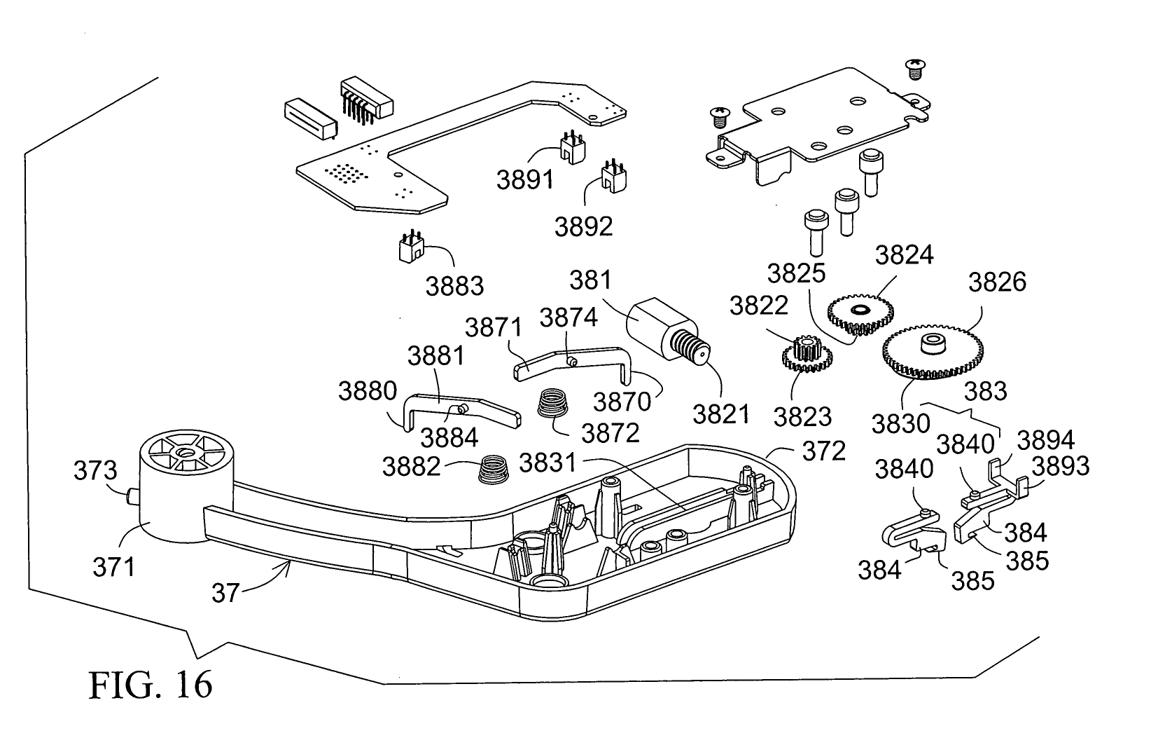

Please refer to FIG. 16 to FIG. 21. The capturing structure (38) comprises: a second power unit (381) (which is a motor in this embodiment), a transmission mechanism (382), a driving mechanism (383) and at least two capturing members (384), (384). The transmission mechanism (382) can be driven by the second power unit (381). The transmission mechanism (382) comprises: a screw gear (3821) and gears (3822), (3823), (3824), (3825) and (3826). The driving mechanism (383) is connected to the transmission mechanism (382). The driving mechanism (383) has an elliptical cam (3830), two capturing members (384), (384), which both further comprise a roller (3840), (3840) that separately and slidably touches the cam (3830) of the driving mechanism (383). When the cam (3830) is rotating, the capturing members (384), (384) are driven by the two rollers (3840), (3840) and guided by a guide rail (3831) to close or open.

Please refer to FIG. 16 to FIG. 21. The capturing structure (38) further comprises: a first sensing switch set (387) and a second sensing switch set (388). The first sensing switch set (387) includes: a first touching sensor (3871), a spring (3872) and a sensing switch (3873). The first touching sensor (3871) is pivoted onto the rotating unit (37) by a pivot (3874). One end of the first touching sensor (3871) has a touching area (3870) protruding through the rotating unit (37), and the protruding portion is near the capturing members (384), (384). Furthermore, the spring (3872) is placed between another end of the first touching sensor (3871) and the rotating unit (37) so that the touching area (3870) of the first touching sensor (3871) can flexibly protrude from the rotating unit (37). When the touching area (3870) of the first touching sensor (3871) is pushed up by the compact disc, the sensing switch (3873) at another end of the first touching sensor (3871) generates electronic signals.

Please refer to FIG. 16 to FIG. 21. The first sensing switch set (388) includes: a second touching sensor (3881), a spring (3882) and a sensing switch (3883). One end of the second touching sensor (3881) has a touching area (3880) protruding through the rotating unit (37), and this protruding portion is near the circumference of the compact disc. The second touching sensor (3881) is pivoted onto the rotating unit (37) by a pivot (3884). The spring (3882) is placed between another end of the second touching sensor (3881) and the rotating unit (37) so that the touching area (3880) of the second touching sensor (3881) can flexibly protrude from the rotating unit (37). When the touching area (3880) of the second touching sensor (3881) is pushed up by the compact disc due to the capturing structure (38) having a deviation in the descent position, the sensing switch (3883) at another end of the second touching sensor (3881) generates electronic signals to inform an electronic control unit (not shown) to perform re-alignment.

Please refer to FIG. 16 to FIG. 21. Each capturing member (384) has: a hook (385) and a stopping block (386). The hook (385) has a sharp V-type edge. The stopping block (386) touches the compact disc, and a distance between the hook (385) and the stopping block (386) is defined as a capturing thickness (T2). The capturing thickness (T2) is larger than the minimum compact disc thickness (T2) and smaller than the maximum compact disc thickness (T3); in another words, T1<T2<T3, so the hook (385) can accurately reach into a gap (435) between two stacked up compact discs to grab the top compact disc.

Please refer to FIG. 16 to FIG. 21. In order control the movement of the two capturing members (384), there are two sensing areas (3893) and (3894) placed on one of the capturing members (384), (384), and a sensing switch (3891) and (3892) placed at both ends of the guide rail (3831) to precisely control the movement of the two capturing members (384), (384).

When the capturing structure (38) is going to grab a compact disc, the protrusive section (373) of the rotating unit (37) moves along the guide track (42) to the position of the first compact disc storage unit (32), and then moves down along the second lifting section (423). When the capturing structure (38) moves down and causes the stopping block (386) of the two capturing members (384), (384) to touch the compact disc and move back up, the first touching sensor (3871) drives the sensing switch (3873) to an active state; the second power unit (381) drives the cam (3830) to rotate after being decelerating by the screw gear (3821) and the gears (3822), (3823), (3824), (3825) and (3826); via the rotation of the cam, the two rollers (3840), (3840) drive two capturing members (384), (384) to be guided by the guide rail (3831) and close to grab the compact disc from the first compact disc storage unit (32). Additionally, the hooks (385) of the two capturing members (384), (384) reach through the central hole (433) of the compact disc 43, since the capturing thickness (T2) is larger than the minimum compact disc thickness (T1) and smaller than the maximum compact disc thickness (T3); in another words, T1<T2<T3, so that the hook (385) can accurately reach into a gap (435) between two stacked up compact discs to grab the top compact disc.

When the capturing structure (38) grabs the compact disc at the first compact disc storage unit (32), the protrusion section (373) of the rotating unit (37) rotates to a position above the waiting position along the first rotating section (422) of the guide track (42). The protrusion section (373) of the rotating unit (37) moves down to the waiting position along the first lifting section (421) of the guide track (42), and the capturing structure (38) precisely places a grabbed compact disc onto the compact disc horizontal transportation device (312) of the compact disc processing device (31). The compact disc horizontal transportation device (312) sends the compact disc into the compact disc processing device (31) to undergo a processing process.

After the processing process has completed, the compact disc horizontal transportation device (312) sends the processed compact disc to the waiting position. If the compact disc has successfully undergone the processing process, the capturing structure (38) grabs the compact disc and remains at the same position; the compact disc horizontal transportation device (312) moves back to the compact disc processing device (31), and the protrusion section (373) of the rotating unit (37) moves down to the second compact disc storage unit (33) along the first lifting section (421) of the guide track (42) for storage. If the compact disc has not successfully undergone the processing process, the protrusion section (373) of the rotating unit (37) rotates to the third compact disc storage unit (35) along the first rotating section (422) and the second rotating section (424) of the guide track (42) for disposal.

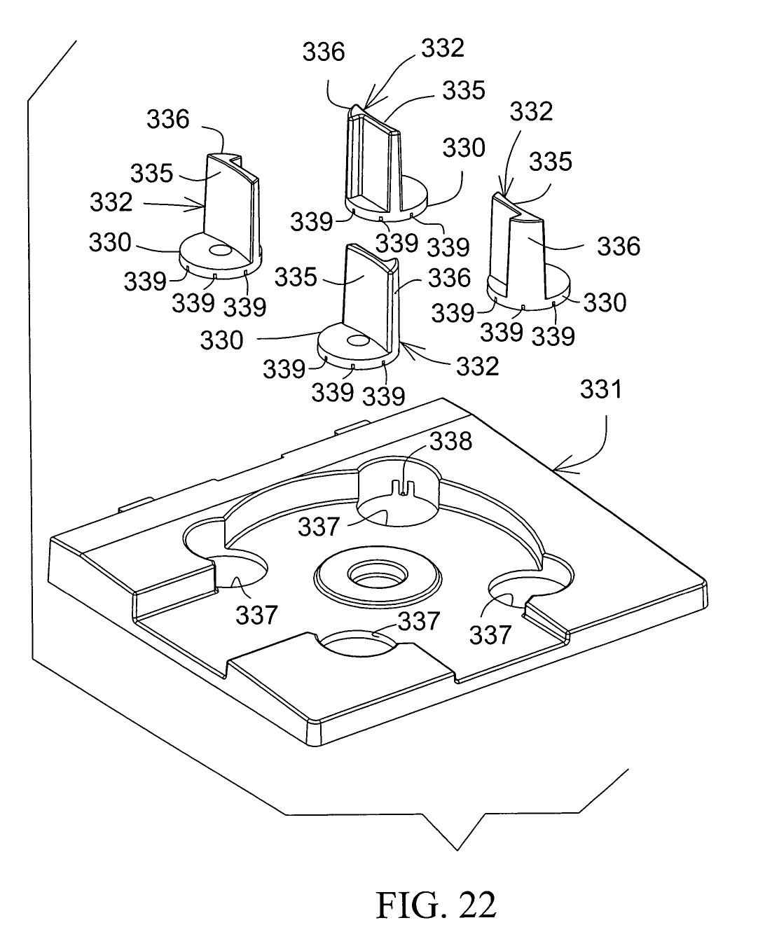

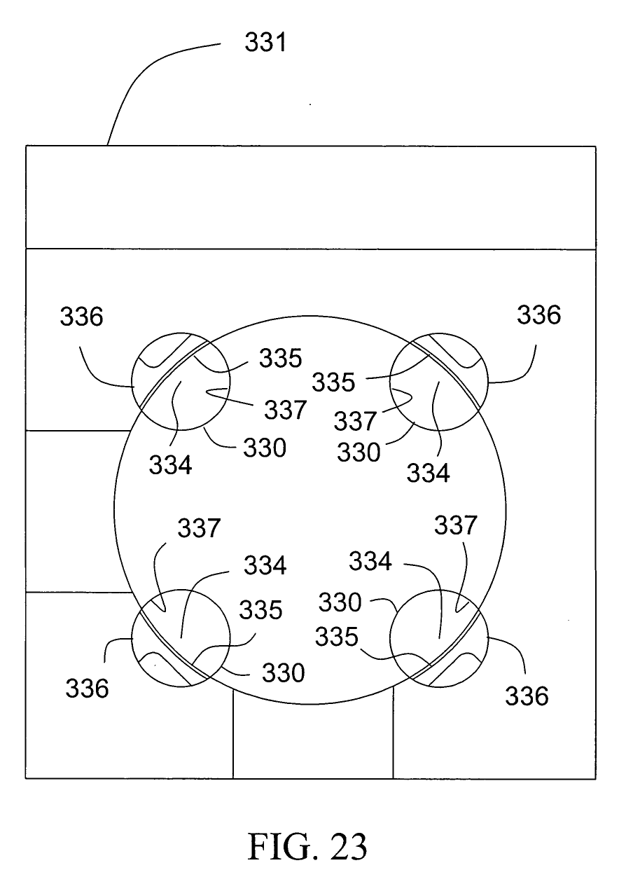

Please refer to FIG. 1 to FIG. 6, FIG. 22 and FIG. 23. In order to load different sized compact discs, the second compact disc storage unit (33) comprises: a compact disc seat (331) and a plurality of (three or more than three) compact disc positioning members (332). The compact disc seat (331) has a positioning hole seat (337), and every positioning hole seat (337) has a bayonet (338). Each compact disc positioning member (332) has a pivot center (334) and a pivot section (330) (as shown in FIG. 22) concentric with the pivot center (334). Every pivot section (330) has a plurality of positioning openings (330) for selectively being fastening with the one of the bayonets (338) of the positioning hole seat (337) to adjust an angle between the compact disc positioning members (332) and the compact disc seat. Each compact disc positioning member (332) has a plurality of positioning edges (335), (336), and each positioning edge has a different distance to the pivot center (334); in this embodiment, three compact disc positioning members (332) are placed 120° away from each other by pivoting the plurality of compact disc positioning members relatively to the compact disc seat to set the positioning edges of the compact disc positioning members so that an concentric circle with a predetermined diameter can be defined for placing different sized compact discs.

The present invention provides a transportation method for compact discs which comprises: a compact disc horizontal carrying device (312) in a compact disc processing device (31) that extends internally from the compact disc processing device (312) to provide a waiting position for loading or unloading a compact disc; placing a first compact disc storage unit above the top section (311) of the compact disc processing device (31) to define a first compact disc storage position for storing a compact disc; placing a second compact disc storage unit above the top section (311) of the compact disc processing device (31) to define a second compact disc storage position for storing a compact disc; and moving one compact disc between the first compact disc storage position and the waiting position, and between the second compact disc storage position and the waiting position.

Accordingly, any one of the compact disc storage units can be used for storing blank compact discs and/or processed compact discs.

Although the present invention has been explained in relation to its preferred embodiment, it is to be understood that many other possible modifications and variations can be made without departing from the spirit and scope of the invention as hereinafter claimed.

1. A compact disc processing system comprising:
a compact disc processing device having a top section, the compact disc processing device is able to provide a waiting position for loading or unloading at least one compact disc;
a first compact disc storage unit placed above the top section of the compact disc processing device and defining a first compact disc storage position for storing the at least one compact disc;
a second compact disc storage unit placed outside of the compact disc processing device and defining a second compact disc storage position for storing the at least one compact disc; and
a compact disc transportation device for moving the at least one compact disc between the first compact disc storage position and the waiting position, and between the second compact disc storage position and the waiting position.

2. The compact disc processing system as claimed in claim 1, wherein the compact disc processing device comprising a compact disc horizontal carrying device capable of extending from the compact disc processing device to provide the waiting position

3. The compact disc processing system as claimed in claim 1, wherein any one of the compact disc storage units is used for storing blank compact discs.

4. The compact disc processing system as claimed in claim 1, wherein any one of the compact disc storage units is used for storing processed compact discs.

5. The compact disc processing system as claimed in claim 1, wherein any one of the compact disc storage units can be plural and used for storing blank and/or processed compact discs.

6. The compact disc processing system as claimed in claim 1, wherein the compact disc transportation device comprises:
(a) a lifting unit having a vertical central line;
(b) a rotating unit having a first end connected to the lifting unit and rotating around the central line, and a second end;
(c) a capturing structure mounted at the second end of the rotating unit for grabbing the compact disc, the capturing structure having a capturing central point corresponding to a central point of the compact disc; and
(d) a driving device having a first power unit, a screw capable of being driven by the first power unit, the center of the screw being placed along the central line and screwed to the first end of the rotating unit, a guide track mounted along outside of the central line of the lifting unit and slidably connected to the first end of the rotating unit to drive the rotating unit along the central line to move and rotate.

7. The compact disc processing system as claimed in claim 6, wherein the compact disc comprises a circumference, a first compact disc surface connected to one end of the circumference, a second compact disc surface connected to another end of the circumference, a central hole having two ends connected to the first compact disc surface and the second compact disc surface, and a circular protrusion on the first compact disc surface forming a protrusive surface, a distance between the first compact disc surface and the second compact disc surface defining a minimum compact disc thickness, and a distance between the first compact disc surface and the protrusive surface defining a maximum compact disc thickness, the capturing structure of the compact disc processing system comprising:
(a) a second power unit;
(b) a transmission mechanism connected to the second power unit;
(c) a driving mechanism connected to the transmission mechanism; and
(d) at least two capturing members connected to the driving mechanism to close or open, each capturing member comprising a hook having sharp V-type edge, and a stopping block capable of touching the compact disc, a distance between the hook and the stopping block defining a capturing thickness, the capturing thickness being larger than the minimum compact disc thickness and smaller than the maximum compact disc thickness so that the hook can accurately reach into a gap between two stacked compact discs to grab the top compact disc.

8. The compact disc processing system as claimed in claim 6, wherein the guide track of the driving device further comprises:
(a) a first lifting section having a first end and a second end, wherein. the first end and the second end of the first lifting section causes the capturing central point of the capturing structure at the second end of the rotating unit to align with the second compact disc storage position;
(b) a first rotating section having a third end and a fourth end, wherein the third end causes the capturing central point of the capturing structure at the second end of the rotating unit to align with the second compact disc storage position, and the fourth end causes the capturing central point of the capturing structure at the second end of the rotating unit to align with the waiting position; and
(c) a second lifting section having a fifth end and a sixth end, wherein the fifth end causes the capturing central point of the capturing structure at the second end of the rotating unit to align with the waiting position, and the sixth end causes the capturing central point of the capturing structure at the second end of the rotating unit to align with the first compact disc storage position.

9. The compact disc processing system as claimed in claim 8, wherein the first end and the second end of the first lifting section further respectively comprises a positioning section for the first end of the rotating unit to touch against for positioned lifting.

10. The compact disc processing system as claimed in claim 8, wherein the third end and the fourth end of the first lifting section further respectively comprises a positioning section for the first end of the rotating unit to touch against for positioned lifting.

11. The compact disc processing system as claimed in claim 8, wherein the fifth end and the sixth end of the first lifting section further respectively comprises a positioning section for the first end of the rotating unit to touch against for positioned lifting.

12. The compact disc processing system as claimed in claim 8 further comprising a third compact disc storage unit placed outside of the compact disc processing device and defining a third storage position for storing the compact disc.

13. The compact disc processing system as claimed in claim 12, wherein the guide track of the driving device further comprises:
(d) a second rotating section having a seventh end and an eighth end, wherein the seventh end causes the capturing central point of the capturing structure at the second end of the rotating unit to align with the waiting position, and the eighth end causes the capturing central point of the capturing structure at the second end of the rotating unit to align outside of the compact disc processing device so that the compact disc drops onto the third compact disc storage position.

14. The compact disc processing system as claimed in claim 13, wherein the seventh end and the eighth end of the second lifting section further respectively comprises a positioning section for the first end of the rotating unit to touch against for positioned lifting.

15. The compact disc processing system as claimed in claim 1, wherein any one of the compact disc storage units comprises:
(a) a compact disc seat; and
(b) a plurality of compact disc positioning members, each compact disc positioning member having a pivot center, the plurality of compact disc positioning members being separately pivoted at different positions on the compact disc seat, each compact disc positioning member having a plurality of positioning edges, each positioning edge having a different distance to the pivot center to selectively set the positioning edges of the compact disc positioning members by pivoting the plurality of compact disc positioning members relatively to the compact disc seat so a concentric circle with a predetermined diameter can be defined for different compact disc sizes.

16. A compact disc processing system comprising:
a compact disc processing device;
a plurality of compact disc storage units placed above a top section of the compact disc processing device for storing a compact disc.

17. The compact disc processing system as claimed in claim 16, wherein any one of the compact disc storage units is used for storing blank compact discs.

18. The compact disc processing system as claimed in claim 16, wherein any one of the compact disc storage units is used for storing processed compact discs.

19. The compact disc processing system as claimed in claim 16, wherein any one of the compact disc storage units can be plural and used for storing blank compact discs and/or processed compact discs.

20. A transportation method for compact discs comprising:
providing a compact disc processing device having a top section to provide a waiting position for loading or unloading at least one compact disc;
placing a first compact disc storage unit above the top section of the compact disc processing device to define a first compact disc storage position for storing the compact disc;
placing a second compact disc storage unit outside of the compact disc processing device to define a second compact disc storage position for storing the compact disc;
moving one compact disc between the first compact disc storage position and the waiting position and between the second compact disc storage position and the waiting position.
